(19) United States
(12) Patent Application Publication
(10) Pub. No.: US 2025/0162679 A1
(43) Pub. Date: May 22, 2025

(54) TILTABLE BICYCLE FRONT SUSPENSION SYSTEM WITH SHOCK ABSORPTION AND COMPOSITE STEERING

(71) Applicant: Guangzhou Plenty Bicycle Co.,Ltd, Guangzhou (CN)

(72) Inventor: LIN LIU, Neijiang (CN)

(73) Assignee: Guangzhou Plenty Bicycle Co.,Ltd, Guangzhou (CN)

(21) Appl. No.: 18/527,198

(22) Filed: Dec. 1, 2023

(30) Foreign Application Priority Data
Nov. 22, 2023 (CN) 2023115659237

(51) Int. Cl. B62K 5/10; B62J 7/06; B62K 5/00; B62K 5/06; B62K 7/04; B62K 25/16

(52) U.S. Cl. CPC B62K 5/10; B62J 7/06; B62K 5/06; B62K 7/04; B62K 25/16; B62K 2005/001

(57) ABSTRACT

The present invention is intended to provide a tiltable bicycle front suspension system with shock absorption and composite steering, including a suspension structure and a steering structure, where the suspension structure includes a vehicle body and symmetrically-arranged front wheels; each front wheel is provided with a steering knuckle; a fork arm fixing frame is movably disposed at one side, far away from the front wheel, of the steering knuckle; an upper fork arm and a lower fork arm, which are arranged in pair, are disposed between the fork arm fixing frame and the vehicle body; an alignment spring is disposed between the upper fork arm and the lower fork arm; and a main shock absorbing spring is disposed between the lower fork arms. The system provided by the present invention can make the driving more accurate and more labor-saving.

### CROSS-REFERENCE TO RELATED APPLICATIONS

The application claims priority to Chinese patent application No. 2023115659237, filed on Nov. 22, 2023, the entire contents of which are incorporated herein by reference.

### TECHNICAL FIELD

The present invention relates to the technical field of bicycles, and in particular to a tiltable bicycle front suspension system with shock absorption and composite steering.

### BACKGROUND

In general, suspension only has two functions of steering and shock absorption in the automotive industry. Freight bicycles on the current market generally only have the above-mentioned functions, or have two functions of deflection and steering. More researches have been conducted on suspension systems in the automotive field, but the development in the field of low-speed vehicles such as the freight bicycles is relatively slow.

Existing shortcomings:
1. No suspension systems optimized for the suspension of bicycles are available on the current market. The common problem is that the steering is stiff, and especially, the riding experience is quite different from that of two-wheeled vehicles during steering. Especially, some products on the market are incapable of tilting leftward and rightward, resulting in very stiff steering during the whole riding process.
2. At present, bicycles with front suspensions of inverted tricycles cannot fully implement both tilting and shock absorption. They are prone to throwing and jumping when encountering bumpiness during cornering, leading to potential safety hazards such as easy rollover.
3. Actually, most of the bicycle steering is just at an ordinary Ackerman geometric steering angle, and there is no optimization for application scenarios of the bicycles in terms of self-alignment. In some cases, an axle pin caster angle is additionally provided to make the bicycles capable of automatically aligning, but it will increase the rollover trend of the tricycles.

### SUMMARY

The present invention is intended to provide a tiltable bicycle front suspension system with shock absorption and composite steering to solve problems existing in the prior art and facilitate popularization.

To achieve the above objective, the present invention adopts the following technical solution:
a tiltable bicycle front suspension system with shock absorption and composite steering, including a suspension structure and a steering structure, where the suspension structure includes a vehicle body and symmetrically-arranged front wheels; each front wheel is provided with a steering knuckle; a fork arm fixing frame is movably disposed at one side, far away from the front wheel, of the steering knuckle; an upper fork arm and a lower fork arm, which are arranged in pair, are disposed between the fork arm fixing frame and the vehicle body; an alignment spring is disposed between the upper fork arm and the lower fork arm; and a main shock absorbing spring is disposed between the lower fork arms.

Further, the steering structure includes a handlebar tube arranged on the vehicle body; a universal joint is disposed at one end, close to the front wheel, of the handlebar tube; one end of the universal joint is hinged with a small arm swinging rod; one end, far away from the universal joint, of the small arm swinging rod is hinged with a linear linkage rod; one end, far away from the small arm swinging rod, of the linear linkage rod is hinged with a big arm swinging rod; one end, far away from the linear linkage rod, of the big arm swinging rod is hinged with an upper right steering pull rod and a lower left steering pull rod; and one end, far away from the big arm swinging rod, of each of the upper right steering pull rod and the lower left steering pull rod, is connected to the steering knuckle, respectively.

Further, the main shock absorbing spring has a shock absorption stroke of 100 mm.

Further, the suspension structure provides a tilt of 22 degrees for the vehicle body.

Further, the upper right steering pull rod and the lower left steering pull rod are structures with ball heads at two ends.

Further, the upper right steering pull rod and the lower left steering pull rod are dual-head screw rod structures.

As an improvement, the present invention has the following beneficial effects:
1. Tilting function: the suspension system can provide a tilt of 22 degrees for the vehicle body. The center of gravity can be lowered and shifted when the turning radius is relatively small. In particular, it can be estimated that the center of gravity can be lowered for 14 mm and laterally shifted for 75 mm, thereby improving the vehicle stability. The movement of the center of gravity toward a bending center can prevent the vehicles from outward rollover, thereby improving the high-speed passing performance. This makes the use experience of the tricycles identical to that of two-wheeled bicycles and improves the travel experience. The alignment spring will help drivers to align from a tilting state. When the cargo is heavier, the compression amount of the alignment spring is greater, and the auxiliary force for alignment is higher. This makes the drivers feel easier to drive.
2. Shock absorption function: central shock absorption makes the vehicle have semi-independent suspension at both sides. Each has a shock absorption stroke of 100 mm. In addition, the aligned shock absorbing spring will participate in the shock absorption of the vehicle when the cargo weight increases, such that the shock absorption has a certain capability of adapting to the weight changes of the vehicle. Then, the influences of the cargo weight on the driving of the vehicle are minimized.
3. Ackerman steering function: similar to cars, this vehicle has a capability of steering for about 35 degrees, and the steering conforms to Ackerman geometry and will not lead to lateral slipping or dragging of the wheels at both sides. Furthermore, a handlebar has a certain ratio and angle of transmission, making the driving more accurate and more labor-saving. In addition, a steering kingpin increases an inclination angle of 10 degrees, allowing the vehicle to automatically align under the action of gravity.

### BRIEF DESCRIPTION OF DRAWINGS

FIG. 1 is a schematic diagram of an overall structure of a tiltable bicycle front suspension system with shock absorption and composite steering of the present invention;

FIG. 2 is a side view of a tiltable bicycle front suspension system with shock absorption and composite steering of the present invention; and

FIG. 3 is a schematic diagram of a local structure of the present invention.

### LIST OF REFERENCE NUMERALS

1: suspension structure; 101: vehicle body; 102: front wheel; 103: steering knuckle; 104: fork arm fixing frame; 105: upper fork arm; 106: lower fork arm; 107: alignment spring; 108: main shock absorbing spring; 2: steering structure; 201: handlebar tube; 202: universal joint; 203: small arm swinging rod; 204: linear linkage rod; 205: big arm swinging rod; 206: upper right steering pull rod; 207: lower left steering pull rod.

### DETAILED DESCRIPTION OF THE EMBODIMENTS

The specific implementations of the present invention are described in more detail below with reference to the accompanying drawings. The same components are denoted by the same reference numerals. It should be noted that, the terms “front”, “back”, “left”, “right”, “upper”, and “lower” used in the following description indicate orientations in the drawings, and the terms “inner” and “outer” indicate orientations toward or far away from the geometric centers of specific components, respectively.

To make the content of the present invention more comprehensible and clearer, the following clearly and completely describes the technical solutions in the embodiments of the present invention with reference to the accompanying drawings in the embodiments of the present invention. The same components are denoted by the same reference numerals.

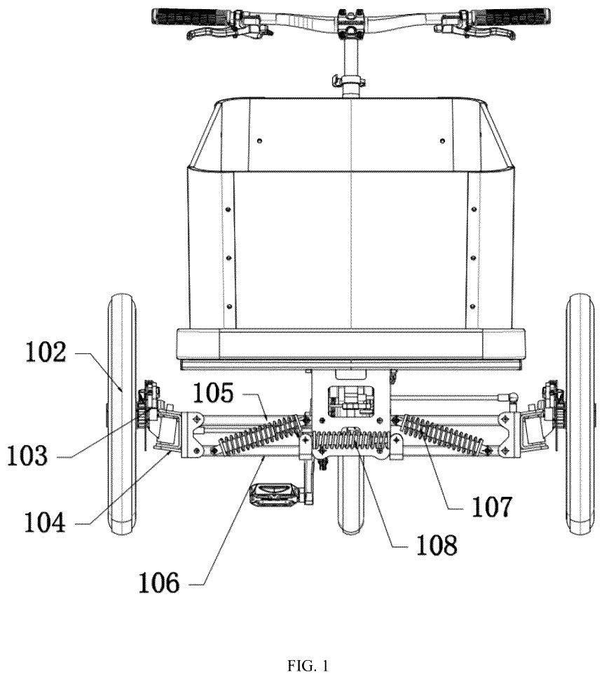

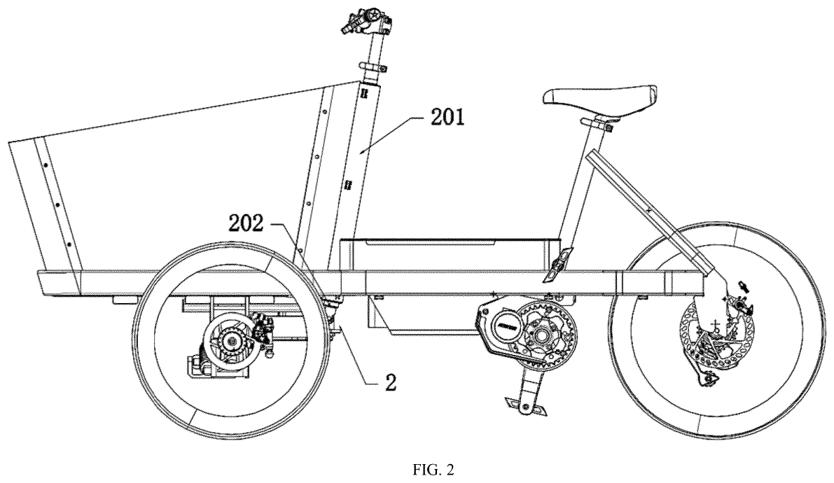

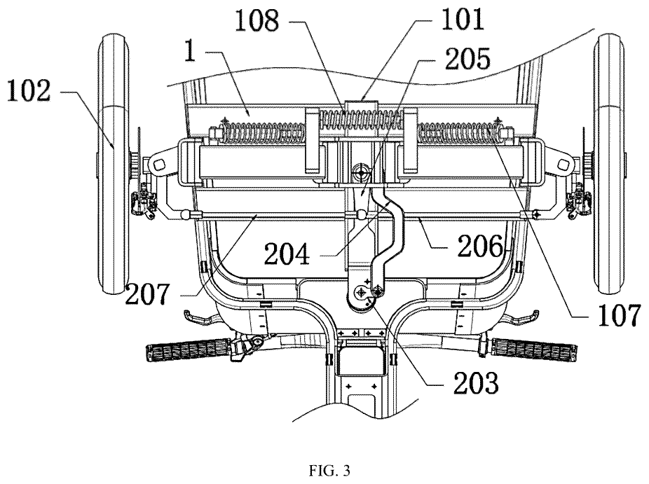

As shown in FIG. 1 to FIG. 3, a tiltable bicycle front suspension system with shock absorption and composite steering, including a suspension structure 1 and a steering structure 2, where the suspension structure 1 includes a vehicle body 101 and symmetrically-arranged front wheels 102; each front wheel 102 is provided with a steering knuckle 103; a fork arm fixing frame 104 is movably disposed at one side, far away from the front wheel 102, of the steering knuckle 103; an upper fork arm 105 and a lower fork arm 106, which are arranged in pair, are disposed between the fork arm fixing frame 104 and the vehicle body 101; an alignment spring 107 is disposed between the upper fork arm 105 and the lower fork arm 106; a main shock absorbing spring 108 is disposed between the lower fork arms 106; the main shock absorbing spring 108 has a shock absorption stroke of 100 mm; the suspension structure 1 provides a tilt of 22 degrees for the vehicle body. The tilting function is that when the center of gravity of a user changes or the vehicle body tilts due to a centripetal force during turning, a parallelogram commonly formed by four parts such as the vehicle body 101, the upper fork arm 105, the lower fork arm 106, and the fork arm fixing frame 104 may be changed due to forces thereon. A suspension system close to the side of a bending center may be deformed, the upper fork arm 105 and the lower fork arm 106 may get close to each other, and the alignment spring 107 at one side may be compressed. At this time, the wheels may tilt toward one side. On the contrary, the other side is far away from the bending center, although the upper fork arm 105 and the lower fork arm 106 are also close, the alignment spring 107 at this side may stretch due to the mirrored. arrangement of the alignment springs 107. At this time, the alignment spring 107 at one side of the vehicle may obviously provide more support force to a vehicle frame, helping the user to align. Meanwhile, the center of gravity of a cargo container may tilt toward the side of the bending center to offset the adverse effects on the driving state of the vehicle, which are caused by part of centrifugal effects.

The shock absorption function is to conduct forces along the directions of the front wheel 102, the steering knuckle 103, the fork arm fixing frame 104, the upper fork arm 105, the lower fork arm 106, the main shock absorbing spring 108, and the vehicle body when the wheel at one side is stressed or the wheels at both sides are stressed. The forces can lift the above structural parts in sequence, leading to the compression of the main shock absorbing spring 108, and further generating a shock absorption effect.

The steering structure 2 includes a handlebar tube 201 arranged on the vehicle body 101; a universal joint 202 is disposed at one end, close to the front wheel 102, of the handlebar tube 201; one end of the universal joint 202 is hinged with a small arm swinging rod 203; one end, far away from the universal joint 202, of the small arm swinging rod 203 is hinged with a linear linkage rod 204; one end, far away from the small arm swinging rod 203, of the linear linkage rod 204 is hinged with a big arm swinging rod 205; one end, far away from the linear linkage rod 204, of the big arm swinging rod 205 is hinged with an upper right steering pull rod 206 and a lower left steering pull rod 207; and one end, far away from the big arm swinging rod 205, of each of the upper right steering pull rod 206 and the lower left steering pull rod 207, is connected to the steering knuckle 103, respectively; the upper right steering pull rod 206 and the lower left steering pull rod 207 are structures with ball heads at two ends, and the upper right steering pull rod 206 and the lower left steering pull rod 207 are dual-head screw rod structures. The steering function is that after being received by a handlebar, a steering torque delivered by the user will be delivered to the universal joint 202. The universal joint 202 continues to deliver the torque to the small arm swinging rod 203, and the swing converts the torque into a linear and rotary composite motion to drive the linear linkage rod 204. The linear linkage rod 204 is connected to the big arm swinging rod 205. The big arm swinging rod 205 is longer than the small arm swinging rod 203, which may increase the stroke according to the lever principle. Then, the user can operate more accurately, and the torque is amplified. This makes the user feel more comfortable, and allows the user to manipulate more accurately. The steering is small and meets the habit of bicycle users, and the torque is amplified. After passing through the big arm swinging rod 205, the motion may be continuously delivered to the upper right steering pull rod 206 and the lower left steering pull rod 207. These two pull rods are provided with ball heads at both sides, and may be used continuously when the suspension is compressed or tilted. The steering pull rods are dual-head screw rods, and the lengths of the pull rods may be adjusted to absorb the manufacturing tolerance.

The above descriptions are merely preferred embodiments of the present invention, and are not intended to limit the patent of the present invention. Any modification, equivalent substitution and improvement without departing from the spirit and principle of the patent of the present invention shall be included within the protection scope of the patent the present invention.

What is claimed is:

1. A tiltable bicycle front suspension system with shock absorption and composite steering, comprising a suspension structure (1) and a steering structure (2), wherein the suspension structure (1) comprises a vehicle body (101) and symmetrically-arranged front wheels (102); each front wheel (102) is provided with a steering knuckle (103); a fork arm fixing frame (104) is movably disposed at one side, far away from the front wheel (102), of the steering knuckle (103); an upper fork arm (105) and a lower fork arm (106), which are arranged in pair, are disposed between the fork arm fixing frame (104) and the vehicle body (101); an alignment spring (107) is disposed between the upper fork arm (105) and the lower fork arm (106); and a main shock absorbing spring (108) is disposed between the lower fork arms (106).

2. The tiltable bicycle front suspension system with shock absorption and composite steering according to claim 1, wherein the steering structure (2) comprises a handlebar tube (201) arranged on the vehicle body (101); a universal joint (202) is disposed at one end, close to the front wheel (102), of the handlebar tube (201); one end of the universal joint (202) is hinged with a small arm swinging rod (203); one end, far away from the universal joint (202), of the small arm swinging rod (203) is hinged with a linear linkage rod (204); one end, far away from the small arm swinging rod (203), of the linear linkage rod (204) is hinged with a big arm swinging rod (205); one end, far away from the linear linkage rod (204), of the big arm swinging rod (205) is hinged with an upper right steering pull rod (206) and a lower left steering pull rod (207); and one end, far away from the big arm swinging rod (205), of each of the upper right steering pull rod (206) and the lower left steering pull rod (207), is connected to the steering knuckle (103), respectively.

3. The tiltable bicycle front suspension system with shock absorption and composite steering according to claim 2, wherein the main shock absorbing spring (108) has a shock absorption stroke of 100 mm.

4. The tiltable bicycle front suspension system with shock absorption and composite steering according to claim 3, wherein the suspension structure (1) provides a tilt of 22 degrees for the vehicle body.

5. The tiltable bicycle front suspension system with shock absorption and composite steering according to claim 4, wherein the upper right steering pull rod (206) and the lower left steering pull rod (207) are structures with ball heads at two ends.

6. The tiltable bicycle front suspension system with shock absorption and composite steering according to claim 5, wherein the upper right steering pull rod (206) and the lower left steering pull rod (207) are dual-head screw rod structures.
